(19) United States
(12) Patent Application Publication
(10) Pub. No.: US 2012/0116641 A1
(43) Pub. Date: May 10, 2012

(54) DRIVE SYSTEM HAVING SLIP CONTROL

(76) Inventors: Alexander C. CROSMAN, III, Dunlap, IL (US); Brandon J. Nordling, Vail, AZ (US)

(21) Appl. No.: 12/939,384

(22) Filed: Nov. 4, 2010

(51) Int. Cl. B60W 30/18

(52) U.S. Cl. 701/84

(57) ABSTRACT

A drive system for a mobile machine is disclosed. The drive system may have a first traction device, a first motor connected to drive the first traction device, and a first sensor configured to generate a first signal indicative of a first rotational speed of the first traction device. The drive system may also have a second traction device, a second motor connected to drive the second traction device, and a second sensor configured to generate a second signal indicative of a second rotational speed of the second traction device. The drive system may further have a controller configured to make a first determination of a difference between the first rotational speed and the second rotational speed greater than a threshold difference based on the first and second signals, and to adjust a propelling torque of at least one of the first and second motors based on the first determination.

### TECHNICAL FIELD

This disclosure relates generally to a drive system and, more particularly, to a drive system having slip control.

### BACKGROUND

Vocational machines such as, for example, on- or off-highway haul trucks, wheel loaders, motor graders, and other types of heavy machinery generally include a power source and multiple traction devices that are directly or indirectly driven by the power source. Modern machines include motors connected between the power source and the traction devices that receive electric or hydraulic power from the power source and produce a corresponding mechanical torque directed to the traction devices.

In some situations such as loading, unloading, uneven loading, or traveling over inconsistent, inclined, soft, or loose terrain, it may be possible for the driven traction devices to slip or spin at a speed different than a traveling speed of the associated machine. Slipping can decrease machine efficiency, increase wear of the traction devices, decrease life of associated drive train components, and possibly result in unexpected or undesired movement of the machine.

Traditionally, slip of electrically-driven traction devices has been addressed by determining that slip is occurring in one of the traction devices and responsively reducing a torque applied by the motor(s) to all of the driven traction devices. For example, U.S. Pat. No. 7,071,642 (the '642 patent) issued to Wilton et al. on Jul. 4, 2006 discloses a method for adaptive control of traction drive units in a hybrid vehicle. The method includes detecting the separate rotational speeds of each of two driven wheels and two non-driven wheels, and comparing each separate speed of the driven wheels either to the speed of the non-driven wheels or to an average of the other three wheel's speeds. If excessive slip is detected in one of the driven wheels, as exhibited by a significant difference in speed between the separate speed of the driven wheel and the non-driven wheel or average speed, motor speeds associated with both of the driven wheels are reduced until the separate speed of the one slipping wheel matches the non-driven wheel or average speed. In this manner, slip can be eliminated.

Although the method of the '642 patent may help reduce wheel slip in some situations, it may be less than optimal. In particular, there may be situations where some wheel slip is desired such as when a thin layer of viscous material is located over a lower surface having a greater coefficient of friction. In this situation, it may be beneficial to allow some slippage to occur such that the thin layer is removed by the slipping traction device and the lower layer is exposed where greater tractive force can be found. The single slip control strategy of the '642 patent does not accommodate these situations.

The disclosed drive system is directed towards overcoming one or more of the problems as set forth above and/or other problems of the prior art.

### SUMMARY

In accordance with one aspect, the present disclosure is directed toward a drive system for a mobile machine. The drive system may include a first traction device, a first motor connected to drive the first traction device, and a first sensor configured to generate a first signal indicative of a first rotational speed of the first traction device. The drive system may also include a second traction device, a second motor connected to drive the second traction device, and a second sensor configured to generate a second signal indicative of a second rotational speed of the second traction device. The drive system may further include a controller in communication with the first motor, the first sensor, the second motor, and the second sensor. The controller may be configured to make a first determination of a difference between the first rotational speed and the second rotational speed greater than a threshold difference based on the first and second signals, and to adjust a propelling torque of at least one of the first and second motors based on the first determination.

According to another aspect, the present disclosure is directed toward another drive system for a mobile machine. This drive system may include a first traction device, a first motor connected to drive the first traction device, a second traction device, and a second motor connected to drive the second traction device. The drive system may also include a controller in communication with the first and second motors. The controller may be configured to implement a first slip control strategy when the first and second motors are propelling the first and second traction devices during a first mode of operation, and to implement a second slip control strategy different from the first slip control strategy when the first and second motors are retarding the first and second traction devices during a second mode of operation.

According to yet another aspect, the present disclosure is directed toward a method of operating a mobile machine. The method may include detecting a first propelling speed of the mobile machine, and detecting a second propelling speed of the mobile machine. The method may further include making a first determination of a difference between the first propelling speed and the second propelling speed greater than a threshold difference, and adjusting a propelling torque of the mobile machine based on the first determination.

### BRIEF DESCRIPTION OF THE DRAWINGS

FIG. 1 is a diagrammatic illustration of a machine having an exemplary disclosed drive system;

FIG. 2 is a graph illustrating an operating principle associated with the drive system of FIG. 1; and

FIG. 3 is a flowchart depicting an exemplary disclosed method of operating the drive system of FIG. 1.

### DETAILED DESCRIPTION

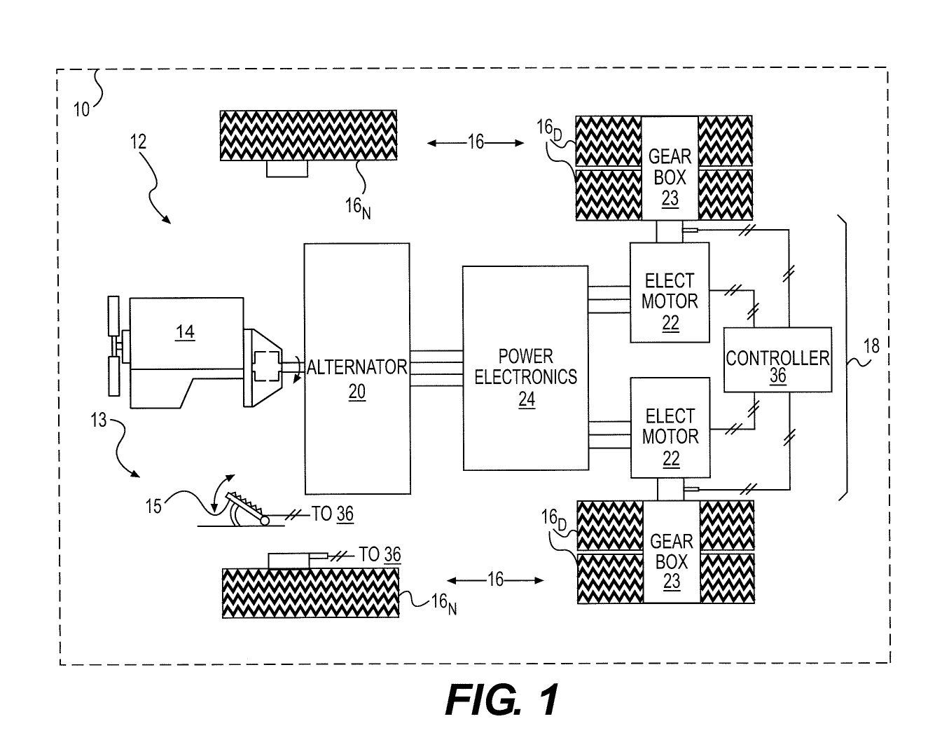

FIG. 1 illustrates an exemplary machine 10. Machine 10 may be a mobile machine that performs some type of operation associated with an industry such as mining, construction, farming, transportation, or any other industry known in the art. For example, machine 10 may be an earth moving machine such as an off-highway haul truck, a wheel loader, a wheel dozer, or another machine known in the art. Machine 10 may alternatively embody an on-highway vocational truck, a bus, a passenger vehicle, or other suitable operation-performing machine.

Machine 10 may be equipped with a drive system 12 having multiple components that interact to propel and retard the motion of machine 10, and an operator station 13 for manual control of drive system 12. Drive system 12 may include a power source 14 configured to generate a power output, a plurality of traction devices 16, and drivetrain 18 configured to transmit the power output from power source 14 to traction devices 16. Operator station 13 may include one or more operator interface devices 15 located proximal an operator seat (not shown) and configured to generate control signals associated with operation of drive system 12. As shown in FIG. 1, one such interface device 15 may include an accelerator and/or decelerator pedal configured to generate a signal indicative of an operator's desire for drive system 12 to propel or retard the motion of machine 10. It should be noted that other operator interface devices 15 are also contemplated for use in controlling drive system 12.

Power source 14, in one embodiment, may include an internal combustion engine configured to produce a mechanical power output. For example, power source 14 may include a diesel engine, a gasoline engine, a gaseous fuel-powered engine, or any other type of combustion engine apparent to one skilled in the art. It is contemplated, however, that power source 14 may alternatively embody a non-combustion source of power such as a fuel cell, a battery, or another source configured to produce an electrical power output. The power output from power source 14 may be received by electric drivetrain 18 and used to power traction devices 16.

Traction devices 16 may embody wheels located on each side of machine 10. In the depicted embodiment, four driven traction devices 16_{D} are located toward a rear-end of machine 10 and arranged in left and right pairs, while two non-driven traction devices 16_{N} are located toward a front-end of machine 10. Non-driven traction devices 16_{N} may be steerable, while driven traction devices 16_{D} may be non-steerable. Each traction device 16 may be independently suspended (i.e., not connected together by an axle). It is contemplated that one or all of traction devices 16 may be replaced with another type of traction device, if desired such as, for example, tracks or belts.

Drivetrain 18 may generally include a driving element and a driven element. In one example, drivetrain 18 may be electrically-based, where the driving element is an electricity generator such as a three-phase permanent magnet alternator 20, and the driven element is an electric motor such as permanent magnet alternating field-type motor 22 configured to receive power from alternator 20. In this configuration, one motor 22 may be linked with each of the left and right pairs of driven traction devices 16_{D} through a direct connection or through an indirection connection, for example through a reducing gear arrangement 23. Alternator 20 may be connected to power each motor 22 with electric current via power electronics 24 in response to a torque command directed to motors 22. In some situations, motors 22 may be configured to operate in reverse direction and thereby generate electric power directed to a storage device (not shown) or to drive alternator 20 via power electronics 24. It is contemplated that drivetrain 18 could alternatively be hydraulically-based, if desired, where the driving element is a pump (not shown) and the driven element is hydraulic motor (not shown).

Power electronics 24 may include generator-associated components and motor-associated components. For example, power electronics 24 may include one or more drive inverters (not shown) configured to invert three-phase alternating power to direct phase power and vice versa. The drive inverters may have various electrical elements including insulated gate bipolar transistors (IGBTs), microprocessors, capacitors, memory storage devices, and any other similar elements used for operating alternator 20 and motors 22. Other components that may be associated with the drive inverter include power supply circuitry, signal conditioning circuitry, and solenoid driver circuitry, among others. In addition, power electronics 24 may include an alternator heat sink (not shown), and a motor heat sink (not shown), each heat sink capable of absorbing heat from their respective components of power electronics 24 and transferring this heat to a cooling system (not shown).

Drive system 12 may further include a control system 28 configured to monitor and affect operation of drive system 12. In one example, control system 28 includes a first speed sensor 30 associated with the paired driven traction devices 16_{D} located on the right side of machine 10, a second speed sensor 32 associated with the paired driven traction devices 16_{D} located on the left side of machine 10, a third speed sensor 34 associated with any of non-driven traction devices 16_{N}, and a controller 36 in communication with each of the speed sensors 30-34 and with motors 22. It is contemplated that control system 30 may include additional and/or different components than those described above, if desired.

Each of first and second speed sensors 30, 32 may embody a magnetic pickup-type sensor configured to provide an indication as to the rotational speeds of their associated driven traction devices 16_{D}. In particular, first and second speed sensors 30, 32 may be associated with the left and right driven traction devices 16_{D}, respectively, be configured to sense a corresponding rotational speed, and produce first and second rotational speed signal. For example, first and second speed sensors 30, 32 may each include a hall-effect element (not shown) disposed proximal a magnet (not shown) embedded within a hub of the their associated driven traction devices 16_{D}, an axle of motors 22, and/or a component of reducing gear arrangement 23 to sense a rotational speed of traction devices 16 and produce the corresponding speed signal. Alternatively, first and/or second speed sensors 30, 32 may embody another type of sensor, for example an optical sensor, if desired. The signals from first and second speed sensors 30, 32 may be directed to controller 36 for further processing and control purposes.

Third speed sensor 34 may embody a magnetic pickup-type sensor configured to provide an indication as to the travel speed of machine 10. Specifically, third speed sensor 34 may include a hall-effect element (not shown) disposed proximal a magnet (not shown) embedded with a hub or axle of any one of non-driven traction devices 16_{N}. Because non-driven traction device 16_{N} may reliably rotate at the same general speed as a travel speed of machine 10 (i.e., because non-driven traction device 16_{N} may not be caused to slip by the torque of motors 22), the rotational speed signal generated by third speed sensor 34 may be relied on for an indication of the travel speed of machine 10. It is contemplated, however, that third speed sensor 34 could alternatively embody another type of speed sensor capable of directly detecting a travel speed of machine 10, for example, a laser sensor, a radar sensor, or a GPS sensor, which may or may not be associated with a hub or axle of non-driven traction devices 16_{N}. The signal from third speed sensor 34 may be directed to controller 36.

Controller 36 may be in communication with interface device 15, motors 22, and sensors 30-34 via digital, analog, or mixed types of communication lines, and configured to regulate operation of these components in response to various input. Controller 36 may embody a single or multiple microprocessors, field programmable gate arrays (FPGAs), digital signal processors (DSPs), etc., that are capable of controlling an operation of drive system 12 in response to the input. Numerous commercially available microprocessors can be configured to perform the functions of controller 36. It should be appreciated that controller 36 could readily embody a microprocessor separate from that controlling other machine functions, or that controller 36 could be integral with a general machine microprocessor and be capable of controlling numerous machine functions and modes of operation. If separate from the general machine microprocessor, controller 36 may communicate with the general machine microprocessor via datalinks or other methods. Various other known circuits may be associated with controller 36, including power supply circuitry, signal-conditioning circuitry, actuator driver circuitry (i.e., circuitry powering solenoids, motors, or piezo actuators), and communication circuitry. It should be noted that, although communications between interface device 15, motors 22, sensors 30-34, and controller 36 have been described as electronic, it is contemplated that communications between these components may alternatively or additionally be implemented by means of mechanical or hydraulic connections, if desired.

Controller 36 may receive signals from speed sensors 30-34, and determine if one or both pairs of driven traction devices 16_{D} are slipping based on the signals. For the purposes of this disclosure, slip may be defined as a relative movement between traction device 16 and a ground surface, for example when driven traction device 16_{D} rotates faster (e.g., spins out) or slower (i.e., skids) than a travel speed of machine 10. Slipping may be determined by comparing the rotational speed signal from first speed sensor 30 with the rotational speed signal from second speed sensor 32 and/or by comparing the travel speed signal from third speed sensor 34 with the rotational speed signals from first and/or second speed sensors 30, 32. When the value of one or more individual rotational speed signals associated with driven traction devices 16_{D} is substantially different than the value of the travel speed signal associated with non-driven traction device 16_{N}, slip may be occurring. When the value of a rotational speed signal associated with one pair of driven traction devices 16_{D} is substantially different than the value of the rotational speed signal associated with the other pair of driven traction devices 16_{D}, one or both pairs of driven traction devices 16_{D} may be slipping. In this situation, if both pairs of driven traction devices 16_{D} are slipping, one pair of driven traction devices 16_{D} may be slipping at a greater rate than the other.

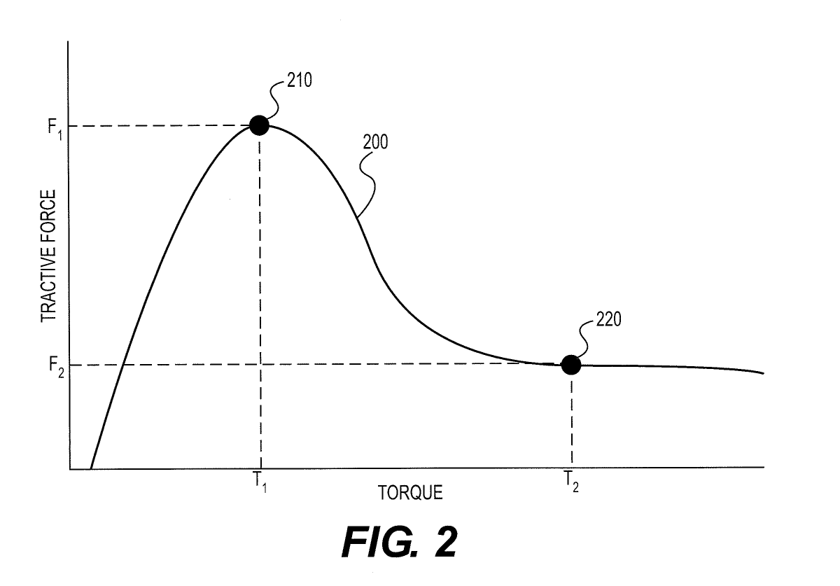

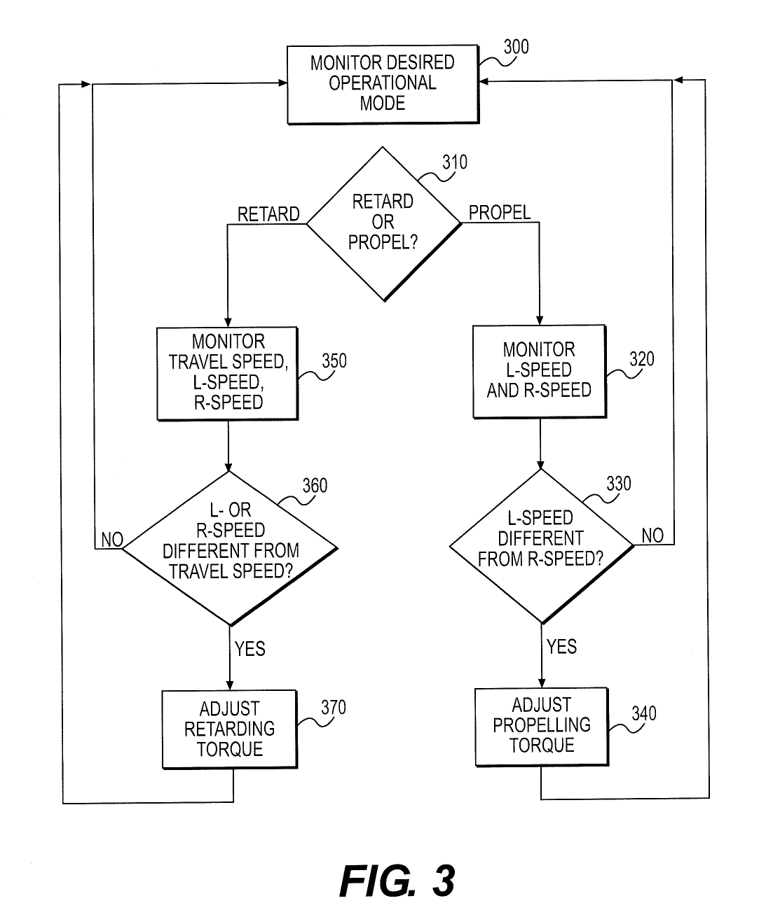

Controller 36 may be configured to adjust an amount of torque transferred from motors 22 to drive traction devices 16_{D} based on detected slip during two different modes of operation. Specifically, controller 36 may adjust the amount of torque transferred from motors 22 to driven traction devices 16_{D} differently when drivetrain 18 is operating in a propel mode of operation (i.e., when motors 22 are directing torque to driven traction devices 16_{D} in a travel direction of machine 10 to accelerate machine 10) and in a retard mode of operation (i.e., when motors 22 are directing torque to driven traction devices 16_{D} against a travel direction of machine 10 to decelerate machine 10). Operation of machine 10 in the propel and retard modes will be described in the following section, in conjunction with FIGS. 2 and 3, to further illustrate the disclosed concepts.

### INDUSTRIAL APPLICABILITY

The disclosed drive system finds potential application in any mobile machine where it is desirable to control slip while protecting the components of the drive system. The disclosed system may improve traction control in some situations by selectively allowing slip to occur based on the current operating mode of the mobile machine. The disclosed system may provide component protection by helping to ensure that slip is occurring under desired conditions in a controlled manner. Operation of drive system 12 will now be described.

During operation of machine 10, an amount of tractive force between traction devices 16 and a ground surface may be related to a torque directed from motors 22 to driven traction devices 16_{D} and a coefficient of friction associated with a ground surface and driven traction devices 16_{D}. Specifically, as illustrated by a curve 200 in FIG. 2, as the torque (T) passed from motors 22 to driven traction devices 16_{D} increases, the tractive force (F) between driven traction devices 16_{D} and the ground surface may also increase at a relatively steady pace. At a point 210 corresponding with a torque T₁ and a tractive force F₁, however, a capacity of the ground surface to resist the tractive force applied by driven traction devices 16_{D} is consumed and the ground surface may begin to erode. That is, at point 210, any additional torque from motor 22 may cause driven traction devices 16_{D} to slip.

Normally, when operating in the propel mode, motors 22 may be commanded to apply a torque level less than T₁ such that slip is prevented or reduced. It has been determined, however, that in some applications, it may be more beneficial for motors 22 to apply an amount of torque greater than T₁ to traction devices 16. For example, when operating on a ground surface consisting of a thin viscous upper layer and a lower layer having a greater coefficient of friction, removal of the upper layer may allow driven traction devices 16_{D} to engage the lower layer and thereby obtain better traction. To remove the viscous upper layer, it may be required for driven traction devices 16_{D} to slip (i.e., spin out), the spinning of traction devices 16 functioning to remove the upper layer and expose the lower layer. For this reason, drive train 18 may be controlled to operate at a point 220 on curve 200 during the propel mode of operation.

FIG. 3 illustrates a method of operating drive system 12. As shown in FIG. 3, the first step of the disclosed method may be to monitor a desired or current operational mode of machine 10 (Step 300). Controller 36 may monitor the desired or current mode of operation by detecting a position and/or status of interface device 15. For example, controller 36 may detect movement of an accelerator and/or decelerator pedal to determine if the operator of machine 10 desires to accelerate or decelerate machine 10. Based on this detection, controller 36 may determine operation in one of the propel and retard modes or, alternatively, cause machine 10 to be operated in one of the propel and retard modes (Step 310). It is contemplated that other methods of determining the desired operational mode of machine 10 may alternatively or additionally be utilized, if desired. For example, a torque output of motors 22 may be monitored by controller 36, if desired. When the torque output of motors 22 increases the acceleration of machine 10, the current operating mode may be propel. In contrast, when the torque output of motors 22 resists the motion of machine 10, the current operating mode may be retard.

When operating in the propel mode (Step 310: Propel), controller 36 may be configured to monitor only the rotational speeds of the left and right pairs of driven traction devices 16_{D} (i.e., the propelling speeds of machine 10) (Step 320). Controller 36 may compare the signals from first and second speed sensors 30, 32, and make a first determination of a difference between the corresponding rotational speeds of left and right driven traction devices 16_{D} (Step 330). If the rotational speed of the left pair of driven traction devices 16_{D} is significantly different than the rotational speed of the right pair of driven traction devices 16_{D}, it may be concluded that at least one of the pairs of driven traction devices 16_{D} is slipping. In this situation, it may be possible for both pairs of driven traction devices 16_{D} to be slipping, but with one pair of driven traction devices 16_{D} slipping at a greater rate than the other pair of driven traction devices 16_{D}. As described above, it may be desirable in some situations for driven traction devices 16_{D} to spin, as the spinning may help to remove the thin viscous upper layer of the ground surface and expose the lower layer.

Controller 36, while allowing driven traction devices 16_{D} to spin, may still be configured to control the spinning. That is, uneven spinning of driven traction devices 16_{D} may reduce the overall tractive force between driven traction devices 16_{D} and the ground surface, and potentially cause machine 10 to move unpredictably. For this reason, controller 36 may be configured to adjust the propelling torque applied by motors 22 to driven traction devices 16_{D} (Step 340) based only on the rotational speeds of driven traction devices 16_{D} (i.e., regardless of a travel speed or machine 10 or a rotational speed of non-driven traction devices 16_{N}). In one embodiment, controller 36 may be configured to reduce the propelling torque of motor 22 associated with the one pair of driven traction devices 16_{D} rotating at a higher speed. In another embodiment, controller 36 may be configured to increase the propelling torque applied by motor 22 to the one pair of driven traction devices 16_{D} rotating at a slower speed. In yet another embodiment, controller 36 may be configured to simultaneously increase the propelling torque of one motor 22 and decrease the propelling torque of the other motor 22 until the rotational speeds of all driven traction devices 16_{D} are about equal. In increasing the propelling torque of motors 22 in response to slip detection during the propel mode of operation, it is contemplated that controller 36 may implement a maximum slip limit, if desired. The maximum slip limit may be a function of a travel speed of machine 10, as detected by third speed sensor 34.

Controller 36 may be configured to implement a different slip control strategy when machine 10 is operating in the retard mode. Specifically, returning to step 310, when controller 36 determines operation in the retard mode or, alternatively, implements machine operation in the retard mode, controller 36 may monitor the signals from all of speed sensors 30-34 (Step 350), and make a second determination as to whether any one or both rotational speeds of the pairs of driven traction devices 16_{D} differ from the travel speed of machine 10 (Step 360). If it is determined that the rotational speed of a pair of driven traction device 16_{D} is less than a travel speed of machine 10, it can be concluded that the particular driven traction device 16_{D} is slipping (i.e., skidding). If, at step 360, it is determined that one or both pairs of driven traction devices 16_{D} are rotating at a speed less than the travel speed, a retarding force of motor 22 may be adjusted. That is, the motor 22 associated with the slipping driven traction device 16_{D} may be reduced to decrease an amount of slip that driven traction device 16_{D} is experiencing.

Because the disclosed drive system may selectively allow slipping of driven traction devices 16_{D} in some situations, traction control may actually be improved. That is, as described above, when operating on a thin viscous ground surface layer, spinning may help to remove the layer, thereby exposing a lower layer that provides better traction. In addition, the ability to implement two different slip control strategies based on machine modes of operation may allow for enhanced slip control during different situations.

It will be apparent to those skilled in the art that various modifications and variations can be made to the drive system of the present disclosure. Other embodiments of the drive system will be apparent to those skilled in the art from consideration of the specification and practice of the drive system disclosed herein. For example, it is contemplated that, when implementing slip control in either the propel or retard modes of operation, controller 36 may account for machine turning, if desired. In particular, during machine turning, it may be possible for one of traction devices 16 to turn at a speed different from another traction device 16 without slipping. For this reason, controller 36, in some embodiments, may be configured to account for this turn-related speed difference. In addition, although controller 36 has been described as utilizing input from physical speed sensors during motor regulation, it is contemplated that the physical sensors may alternatively be replaced with virtual sensors, if desired. That is, controller 36 may be configured to determine a speed of driven traction devices 16D in an indirect manner known in the art. It is intended that the specification and examples be considered as exemplary only, with a true scope of the invention being indicated by the following claims and their equivalents.

What is claimed is:

1. A drive system for a mobile machine, comprising:
a first traction device;
a first motor connected to drive the first traction device;
a first sensor configured to generate a first signal indicative of a first rotational speed of the first traction device;
a second traction device;
a second motor connected to drive the second traction device;
a second sensor configured to generate a second signal indicative of a second rotational speed of the second traction device; and
a controller in communication with the first motor, the first sensor, the second motor, and the second sensor, the controller being configured to:
make a first determination of a difference between the first rotational speed and the second rotational speed greater than a threshold difference based on the first and second signals; and
adjust a propelling torque of at least one of the first and second motors based on the first determination.

2. The drive system of claim 1, wherein the controller is configured to reduce the propelling torque of one of the first and second motors associated with the one of the first and second traction devices having a higher rotational speed based on the first determination.

3. The drive system of claim 2, wherein the controller is configured to reduce the propelling torque until the first and second rotational speeds are about equal.

4. The drive system of claim 1, wherein the controller is configured to increase the propelling torque of the one of the first and second motors associated with the one of the first and second traction device having a lower rotational speed based on the first determination.

5. The drive system of claim 4, wherein the controller is configured to increase the propelling torque until the first and second rotational speeds are about equal.

6. The drive system of claim 1, wherein the controller is configured to simultaneously increase the propelling torque of one of the first and second motors and reduce the propelling torque of the other of the first and second motors based on the first determination.

7. The drive system of claim 1, wherein the controller is configured to adjust the propelling torque regardless of a difference between a travel speed of the mobile machine and the first or second rotational speeds.

8. The drive system of claim 1, further including a non-driven traction device, wherein the propelling torque of the one of the first and second motors having a higher speed is adjusted regardless of a difference between a rotational speed of the non-driven traction device and the first or second rotational speeds.

9. The drive system of claim 1, further including a travel speed sensor configured to generate a third signal indicative of a travel speed of the mobile machine, wherein the controller is further configured to:
make a second determination of a difference between the travel speed and at least one of the first and second rotational speeds greater than a threshold difference based on the first, second, and third signals; and
adjust a retarding torque of one of the first and second motors associated with the at least one of the first and second rotational speeds based on the second determination.

10. The drive system of claim 9, wherein the controller is configured to reduce the retarding torque of the one of the first and second motors associated with the one of the first and second traction devices having a slower rotational speed based on the second determination.

11. A drive system for a mobile machine, comprising:
a first traction device;
a first motor connected to drive the first traction device;
a second traction device;
a second motor connected to drive the second traction device; and
a controller in communication with the first and second motors, the controller being configured to:
implement a first slip control strategy when the first and second motors are propelling the first and second traction devices in a first mode of operation; and
implement a second slip control strategy different from the first slip control strategy when the first and second motors are retarding the first and second traction devices in a second mode of operation.

12. The drive system of claim 11, further including:
a first sensor configured to generate a first signal indicative of a first rotational speed of the first traction device;
a second sensor configured to generate a second signal indicative of a second rotational speed of the second traction device; and
a third sensor configured to generate a third signal indicative of a travel speed of the mobile machine, wherein the controller is configured to:
implement the first slip control strategy based on a difference between the first and second signals; and
implement the second slip control strategy based on a difference between the third signal and the first or second signals.

13. The drive system of claim 12, wherein, during implementation of the first slip control strategy, the controller is configured to reduce a propelling torque of the one of the first and second motors associated with the one of the first and second traction devices having a higher rotational speed based on a difference between the first and second rotational speeds being greater than a threshold difference.

14. The drive system of claim 12, wherein, during implementation of the second slip control strategy, the controller is configured to reduce a retarding torque of the one of the first and second motors associated with the one of the first and second traction devices having a lower rotational speed based on a difference between the travel speed and the first or second rotational speeds being greater than a threshold difference.

15. A method of controlling slip of a mobile machine, comprising:
detecting a first propelling speed of the mobile machine;
detecting a second propelling speed of the mobile machine;
making a first determination of a difference between the first propelling speed and the second propelling speed greater than a threshold difference; and
adjusting a propelling torque of the mobile machine based on the first determination.

16. The method of claim 15, wherein adjusting includes reducing the propelling torque associated with a higher one of the first and second propelling speeds based on the first determination.

17. The method of claim 15, wherein adjusting includes increasing the propelling torque associated with the lower of the first and second propelling speeds based on the first determination.

18. The method of claim 15, wherein adjusting includes simultaneously increasing the propelling torque associated with a higher one of the first and second propelling speeds and reducing the propelling torque associated with the lower of the first and second propelling speeds based on the first determination.

19. The method of claim 15, further including adjusting the propelling torque regardless of a difference between a travel speed of the mobile machine and the first or second propelling speeds.

20. The method of claim 15, further including:
detecting a travel speed of the mobile machine;
making a second determination of a difference between the travel speed and at least one of the first and second propelling speeds greater than a threshold difference; and
adjusting a retarding torque of the mobile machine based on the second determination.
